(19) United States
(12) Patent Application Publication
(10) Pub. No.: US 2023/0124381 A1
(43) Pub. Date: Apr. 20, 2023

(54) POWER POD SYSTEM AND ASSEMBLY

(71) Applicant: Regal Beloit America, Inc., Beloit, WI (US)

(72) Inventors: Scott PHILLIPS, Valparaiso, IN (US); Kim HOFFMANN, Chesterton, IN (US)

(21) Appl. No.: 17/504,603

(22) Filed: Oct. 19, 2021

(51) Int. Cl. G01D 11/00; H01R 13/62

(52) U.S. Cl. CPC G01D 11/00; H01R 13/6205

(57) ABSTRACT

A power sensor assembly including a sensor system having a sensor component, a circuit system, and a power receptacle system contained within a sensor housing, and further including a first power pod system having one or more power sources configured to output electrical energy, a power supply interface system operably coupled with the one or more power sources, the power supply interface system selectively connectable with the power receptacle system of the sensor system to transfer power from the one or more power sources to the sensor system, and a housing containing the one or more power sources and the power supply interface system, the housing of the first power pod system being separate from the sensor housing.

### FIELD

The present disclosure relates to a power supply system and, more particularly, relates to a power supply system capable of externally attaching to a sensor system to form a power sensor assembly.

### BACKGROUND AND SUMMARY

This section provides background information related to the present disclosure which is not necessarily prior art. This section provides a general summary of the disclosure, and is not a comprehensive disclosure of its full scope or all of its features.

Sensors are ubiquitous in manufacturing systems of today. However, in many applications, the sensors used are often delicate and easily damaged through impact and/or contamination caused by chemicals, fluids, and/or general exposure. In order to properly protect sensors in such applications, sensors are often disposed and/or contained within a housing device that shields the sensor from damage and/or exposure. In some industries, sensor housing enclosures must be minimized in size to ensure proper compatibility with nearby systems. In some industries, the sensor housing enclosures must be sealed to prevent exposure of the sensor to contamination and the like.

Furthermore, because sensors are often used in application that do not have a readily-available power source, sensors may be powered by a self-contained internal power source, such as a battery or other charger, that is contained within the sensor housing. Unfortunately, it is abundantly clear that the useful life of a battery is finite as it will discharge over time due to non-use or dissipate over time through normal use.

To accommodate these power demands, one must provide for power replenishment of internal power sources, which typically includes replacement of the internal battery or power source, or installation of a larger capacity internal battery. Replacement of the internal battery, especially in sealed sensor applications, typically requires opening the sealed housing containing the sensor assembly and battery, which results in breaking the environmental seal that is protecting the sensor and associated componentry. This can lead to contamination and/or failure of the sensor system.

Likewise, replacement of an existing internal battery with a larger capacity battery (often being larger) can require use of a larger sensor housing. If sealing systems are used, this can increase the cost of the housing significantly.

It should also be recognized that batteries or power sources mounted within sensor housing enclosures are often a source of heat that can result in decreased performance of the electronic circuitry and/or sensor, and may further result in decrease component life.

Therefore, there is a need in the art to provide a replenishable power source that can be used with sensor systems that does not require the opening of the sensor housing and, thus, is able to maintain a sealed condition. Moreover, there is a need in the art to provide a power source that can be used with sensor systems that is easily expandable to greater capacity without requiring a change in sensor housing size. Finally, there is a need in the art to provide a power system that overcomes the disadvantages of the prior art.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a schematic view illustrating a power pod and sensor system assembly using a stud mounting assembly according to the principles of the present teachings.

FIG. 1B is a schematic view illustrating a power pod and sensor system assembly using a magnetic mounting assembly according to the principles of the present teachings.

FIG. 1C is a schematic view illustrating a power pod and sensor system assembly using a thread mounting assembly according to the principles of the present teachings.

FIG. 2 is a perspective view illustrating a power pod and sensor system assembly having an inductance-type charging connection according to the principles of the present teachings.

FIG. 3 is a perspective view illustrating a power pod and sensor system assembly having a wired connection and illustrating rechargeable capability according to the principles of the present teachings.

FIG. 4 is a perspective view illustrating a power pod and sensor system assembly having a wireless connection according to the principles of the present teachings.

FIG. 5A is a perspective view illustrating a power pod according to the principles of the present teachings.

FIG. 5B is a perspective view illustrating a power pod according to the principles of the present teachings.

FIG. 5C is a perspective view illustrating a pair of stacked power pods according to the principles of the present teachings.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or features relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

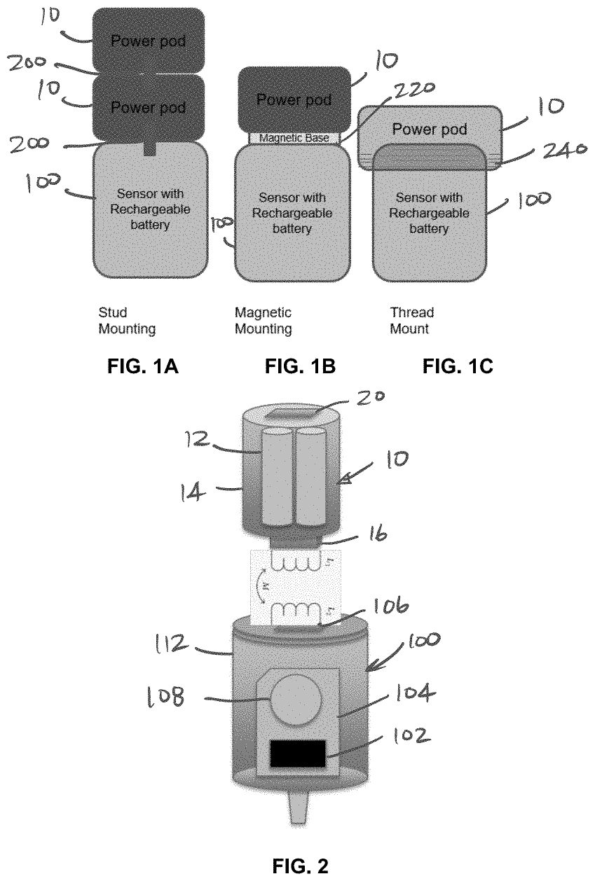

According to the principles of the present teachings, as illustrated in FIGS. 1A-5C, a power pod system 10 is provided that is configured to provide electrical power to a sensor system 100.

In some embodiments, as illustrated in FIGS. 1A-4, sensor system 100 comprises one or more sensor components 102 configured to sense a parameter, such as temperature, vibration, fluid flow, and the like, and output a sensor signal. In some embodiments, sensor system 100 comprises the sensor components 102, a circuit system or board 104, an external power receptacle system 106, an optional onboard power source 108, a sensor system 110 for receiving the sensor signal and outputting an operational signal, contained within a sensor housing 112. It should be understood that sensor system 110 can comprise any one of a number of sensor related components and can further include any one of a number of processing components or systems to process information, provide alarm indications, analyze data, or provide desired functionality.

In some embodiments, sensor housing 112 comprises an internal volume or chamber 114 sized to receive at least sensor components 102 and associated circuitry necessary to operable couple sensor components 102 to external power receptacle system 106. Sensor housing 112 can be sealed in to minimize introduction of contamination within internal volume 114. In some embodiments, sensor housing 112 can be sealed such that an enhanced sealing engagement is attained in accordance with enhanced industry protocols and/or standards. In some embodiments, sensor housing 112 can be permanently sealed to prevent access to internal volume 114.

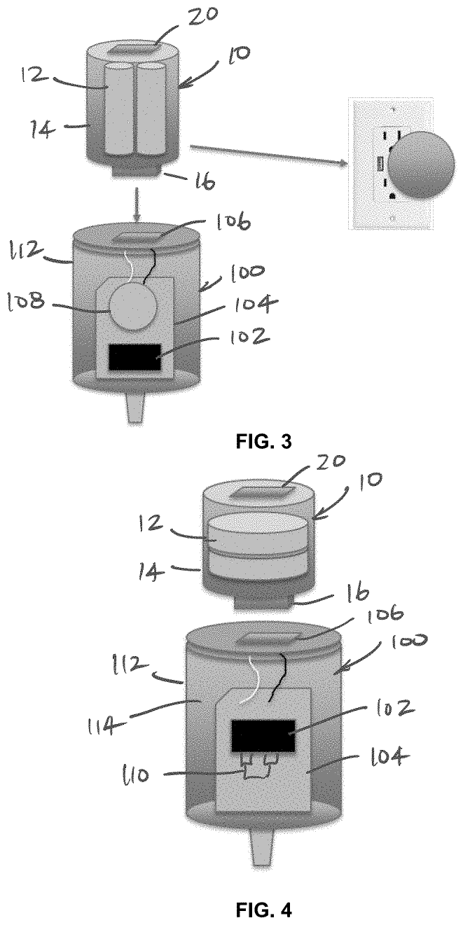

In some embodiments, as illustrated in FIG. 2, sensor system 100 does not comprise power source 108. Therefore, as will be described herein, sensor system 100 will obtain operational power from one or more power pods 10 in accordance with the present teachings. In this way, power pods 10, when coupled with sensor system 100 via power receptacle system 106, such as the depicted inductance charging (or any other charging and/or powering connecting) will operate as a primary power source for operation of sensor system 100. However, in some embodiments as illustrated in FIGS. 3-4, sensor system 100 comprises an onboard power source 108. Although power source 108 is illustrated as a button battery in FIGS. 3-4, it should be understood that alternative battery configurations can be used. In this way, power pods 10, when coupled with sensor system 100 via power receptacle system 106, will operate as a secondary, ancillary, and/or rechargeable power source for operation of sensor system 100.

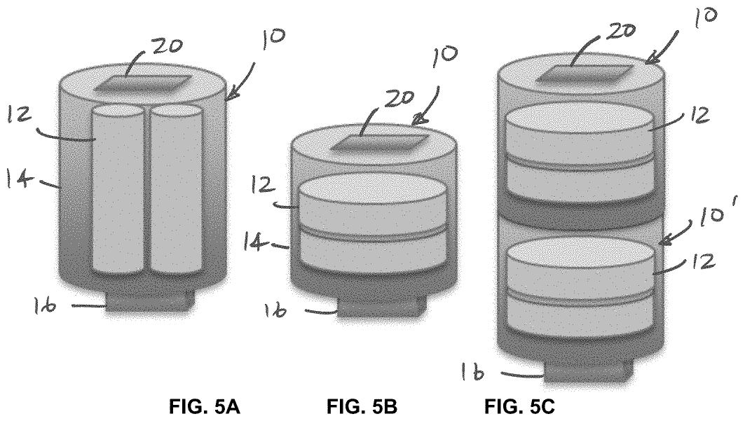

In some embodiments, as particularly illustrated in FIGS. 5A-5C, power pod 10 can comprise one or more power sources 12 contained within a power pod housing 14 operably coupled to a power supply interface system 16. In some embodiments, power sources 12 of power pod 10 can comprise one or more power storage devices, such as lead batteries, alkaline batteries, lithium batteries, rechargeable batteries, capacitors, or other storage means. In some embodiments, power sources 12 can comprise conventional batteries that can be recharged and/or replaced within power pod housing 14, such as AA batteries, button batteries, and the like. It should be understood that alternative charging systems can be employed, such as but not limited to inductance charging (see FIG. 2); solar charging; energy harvesting via thermal, vibration, or other energy; or other methods.

In some embodiments, as illustrated in FIGS. 1A-4, power pod 10 can be operationally coupled to sensor system 100 such that power supply interface system 16 of power pod 10 operationally engages power receptacle system 106 of sensor system 100. In some embodiments, as illustrated in FIGS. 2-3, power supply interface system 16 of power pod 10 can be configured as a wired-type interface whereby power transfer contacts, such as wired contacts, pads, connectors, or other electrical connections, transfer electrical power from power sources 12 of power pod 10 to sensor system 100 (particularly, either onboard power source 108 or directly to sensor components 102). In some embodiments, this wired-type interface can be achieved using industry systems such as Universal Serial Bus (USB), micro-USB, Lightning connector, wires, or the like. Additionally, as illustrated in FIGS. 2-3 and 5A-5C, power supply interface system 16 of power pod 10 can comprise a male connector that is slidably received within a corresponding female connector of power receptacle system 106 of sensor system 100. It should be understood that use of conventional connectors can further permit power pod 10 to be easily recharged by using conventional recharging outlets, as illustrated in FIG. 3.

In some embodiments, as illustrated in FIG. 4, power supply interface system 16 of power pod 10 can be configured as a wireless-type interface whereby a wireless transfer system, such as an inductive charging system, transfer electrical power from power sources 12 of power pod 10 to sensor system 100 (particularly, either onboard power source 108 or directly to sensor components 102). In this way, inductive power transfer can serve to charge onboard power source 108 or supply primary power, while maximizing sealing capacity.

In some embodiments, it is useful to ensure a rugged and/or reliable mounting interface between power pod 10 and sensor system 100. Accordingly, in some embodiments as illustrated in FIGS. 1A-1C, various mounting systems can be used to align and/or retain power pod 10 and sensor system 100 in engagement. As illustrated in FIG. 1A, in some embodiments, power pod 10 can be mounted to sensor system 100 via a stud assembly 200. Stud assembly 200 can comprise a rod, stud, or other mounting member capable of providing alignment and/or retention of power pod 10 to sensor system 100. It should be understood that stud assembly 200 can incorporate power supply interface system 16 or be separate therefrom. As illustrated in FIG. 1B, in some embodiments, power pod 10 can comprise a magnetic base interface 220 to maintain magnetic engagement of power pod 10 to sensor system 100. Likewise, as illustrated in FIG. 1C, in some embodiments, power pod 10 can comprise a threaded or twist lock mount 240 to threadingly engage power pod 10 with sensor assembly 100.

With particular reference to FIGS. 1A and 5C, in some embodiments, power pod 10 can be used in a stackable fashion with one or more additional power pods 10. In this way, as illustrated in FIGS. 2-5C, power pod 10 can comprise a stacking receptacle 20 on an opposing end of power pod 10 opposite power supply interface system 16. In some embodiments, stacking receptacle 20 is identical to power supply interface system 16 such that power supply interface system 16 of first power pod 10 can be plugged or otherwise connected to stacking receptacle 20 of a second power pod 10′. It is anticipated that the interface used to couple power pod 10 to sensor system 100 is identical to the stacking interface between adjacent power pods 10 to permit convenient stacking and expansion to meet a wide variety of power supply needs. Moreover, in this way, power pods 10 of different sizes and capacities can be combined to be various operational needs.

Accordingly, in some embodiments, the present teachings provide a nesting, stackable, and/or expandable power pod system that is particularly configured to be coupled with a sensor system via a magnetic base, USB, or a twist type connection. The power pod and sensor system can be mounted on a bearing, gear case or other machine item that needs monitoring of properties, such as temperature and vibration.

The present teachings provide a number of advantages over conventional systems, including but not limited to being able to provide an scalable, external power supply without having to increase the envelope or container size of the sensor system. The present teachings further provide benefits in preventing unnecessary breaking of factory environmental seals in the sensor system in order to change batteries. Moreover, the power pods can be easily removed and recharged or replaced as necessary. It should be understood that power pod 10 can be configured with a photocell recharging system capable of recharging the power sources 12 to further extend the life of power pod 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power pod system for use with a sensor system, the sensor system having a sensor component, a circuit system, and a power receptacle system contained within a sensor housing, the power pod system comprising:
one or more power sources configured to output electrical energy;
a power supply interface system operably coupled with the one or more power sources, the power supply interface system being configured to operably connect with the power receptacle system of the sensor system to transfer power from the one or more power sources to the sensor system; and
a housing containing the one or more power sources and the power supply interface system, the housing being separate from the sensor housing.

2. The power pod system according to claim 1, further comprising:
a stacking receptacle operably coupled with the one or more power sources.

3. The power pod system according to claim 2, further comprising:
a second power pod system comprising:
one or more power sources configured to output electrical energy;
a power supply interface system operably coupled with the one or more power sources, the power supply interface system being configured to operably connect with the power receptacle system of the sensor system to transfer power from the one or more power sources to the sensor system; and
a housing containing the one or more power sources and the power supply interface system, the housing being separate from the sensor housing.
wherein the power supply interface system of the second power pod is electrically coupled to the stacking receptacle of the first power pod system.

4. The power pod system according to claim 1, wherein the one or more power sources is selected from the group consisting of lead batteries, alkaline batteries, lithium batteries, rechargeable batteries, and capacitors.

5. The power pod system according to claim 1, wherein the power supply interface system comprises a wired interface system.

6. The power pod system according to claim 5, wherein the wired interface system is selected from the group of USB, micro-USB, lightning connectors, and wires.

7. The power pod system according to claim 1, wherein the power supply interface system comprises a wireless interface system.

8. The power pod system according to claim 7, wherein the wireless interface system is an inductive charging system.

9. The power pod system according to claim 1, further comprising:
a mounting system configured to operably coupled the power pod system to the sensor system.

10. A power sensor assembly comprising:
a sensor system having a sensor component, a circuit system, and a power receptacle system contained within a sensor housing;
a first power pod system having one or more power sources configured to output electrical energy, a power supply interface system operably coupled with the one or more power sources, the power supply interface system selectively connectable with the power receptacle system of the sensor system to transfer power from the one or more power sources to the sensor system, and a housing containing the one or more power sources and the power supply interface system, the housing of the first power pod system being separate from the sensor housing.

11. The power sensor assembly according to claim 10 wherein the first power pod system further comprises a stacking receptacle operably coupled with the one or more power sources, wherein the power sensor assembly further comprises:
a second power pod system having one or more power sources configured to output electrical energy, a power supply interface system operably coupled with the one or more power sources, the power supply interface system selectively connectable with the power receptacle system of the sensor system to transfer power from the one or more power sources to the sensor system, and a housing containing the one or more power sources and the power supply interface system, the housing of the second power pod system being separate from the sensor housing, the power supply interface system of the second power pod system being selectively connectable to the stacking receptacle of the first power pod.

12. The power sensor assembly according to claim 10, wherein the one or more power sources is selected from the group consisting of lead batteries, alkaline batteries, lithium batteries, rechargeable batteries, and capacitors.

13. The power sensor assembly according to claim 10, wherein the power supply interface system comprises a wired interface system.

14. The power sensor assembly according to claim 13, wherein the wired interface system is selected from the group of USB, micro-USB, lightning connectors, and wires.

15. The power sensor assembly according to claim 10, wherein the power supply interface system comprises a wireless interface system.

16. The power sensor assembly according to claim 15, wherein the wireless interface system is an inductive charging system.

17. The power sensor assembly according to claim 10, further comprising:
a mounting system configured to operably coupled the first power pod system to the sensor system.

18. The power sensor assembly according to claim 17 wherein the mounting system comprises a stud mounting system.

19. The power sensor assembly according to claim 17 wherein the mounting system comprises a magnetic mounting system.

20. The power sensor assembly according to claim 17 wherein the mounting system comprises a thread mounting system.
